(19) United States
(12) Patent Application Publication
(10) Pub. No.: US 2018/0088768 A1
(43) Pub. Date: Mar. 29, 2018

(54) DISPLAY APPARATUS, DISPLAY METHOD AND DISPLAY SYSTEM

(71) Applicant: CASIO COMPUTER CO., LTD., Tokyo (JP)

(72) Inventor: Atsushi NAKAGAWA, Tokyo (JP)

(73) Assignee: CASIO COMPUTER CO., LTD., Tokyo (JP)

(21) Appl. No.: 15/663,346

(22) Filed: Jul. 28, 2017

(30) Foreign Application Priority Data
Sep. 28, 2016 (JP) 2016-189444

(51) Int. Cl. G06F 3/0488; G06F 3/03; G06F 3/038

(52) U.S. Cl. CPC G06F 3/0488; G06F 3/0304; G06F 3/0425; G06F 2203/0381; G06F 3/038

(57) ABSTRACT

A display apparatus according to embodiments of the invention includes a display unit configured to display an image, a detection unit configured to detect a detection value associated with an input of the image that is outputted from an external terminal, and a control unit configured to control an operation of the display unit based on the detection value detected by the detection unit.

### CROSS-REFERENCE TO RELATED APPLICATION

This application is based on and claims the benefit of priority under 35 USC 119 of Japanese Patent Application No. 2016-189444 filed on Sep. 28, 2016, the entire disclosure of which, including the description, claims, drawings and abstract, is incorporated herein by reference.

### BACKGROUND OF THE INVENTION

### Field of the Invention

The present invention relates to a display apparatus, a display method using the display apparatus and a display system.

### Description of the Related Art

In recent years, there have been promoted external terminals for wireless display adapters that transmit images from a PC (personal computer) to a display in a wireless fashion by making use of wireless networks and multimedia streaming devices that reproduce contents of the Internet.

An external terminal and a main body of a display apparatus are separate systems, and therefore, normally, the external terminal and the display apparatus need to be operated independently. Then, an operation to start display needs to be performed separately and repeatedly on the external terminal and the display apparatus, involving some labor hours. This produces demands for convenient operation methods which enable the external terminal and the display apparatus to work in an associated fashion.

Japanese Unexamined Patent Publication No. 2016-161916 discloses a projector including a projection unit for projecting images and an input unit to which a signal to activate the projection unit for projection is inputted from external equipment. In this projector, whether or not the external equipment is connected to the projector can be determined by detecting the existence of a power supply voltage of +5 [V] from a power supply line which is part of a connection terminal. Additionally, an example is also disclosed in which a VGA terminal, an HDMI (registered trademark), and a USB terminal are used as the connection terminal.

The projector does not receive image data while the external equipment is not used, and therefore, it is desired to suspend the operation of the projector from the viewpoint of reducing the power consumption and the operation noise. On the other hand, once the projector is switched off, it takes some seconds in attempting to start it again. Since the projector is switched on and off in the midst of a meeting or conference, in a case where the projector, which is switched off, needs to be switched on for projection, there is caused inconvenience that the projector cannot be activated for projection on the spot.

In the projector described in Japanese Unexamined Patent Publication No. 2016-161916, whether or not the external equipment is connected to the projector is determined based on the existence of the power supply voltage of the connection terminal. However, it is difficult to determine whether or not the external equipment is in operation. Thus, it is difficult to use smoothly the projector in association with an output of an image from the external equipment.

### SUMMARY OF THE INVENTION

The invention has been made in view of the situations described above, and an object thereof is to provide a display apparatus which operates smoothly in response to an output of an image from external equipment, a display method of the display apparatus and a display system.

According to an aspect of the invention, there is provided a display apparatus including a display unit configured to display an image, a detection unit configured to detect a detection value associated with an input of the image that is outputted from an external terminal, and a control unit configured to control an operation of the display unit based on the detection value detected by the detection unit.

According to another aspect of the invention, there is provided a display method for a display apparatus that includes a display unit configured to display an image, including a first step of detecting a detection value that is associated with an input of the image that is outputted from an external terminal and a second step of controlling an operation of the display unit based on the detected detection value.

According to a further aspect of the invention, there is provided a display system including an external terminal configured to output an image, and a display apparatus including a display unit, a power supplying terminal that is used to supply electric power to the external terminal, an input terminal into which the image outputted from the external terminal is inputted and a control unit configured to control an operation of the display unit based on a detection value that is associated with an input of the image that is inputted by way of the input terminal.

### BRIEF DESCRIPTION OF THE SEVERAL VIEWS OF THE DRAWINGS

FIG. 1 is a drawing showing a projection system according to an embodiment of the invention,

FIG. 2 is a block diagram showing functional blocks of a projector according to the embodiment of the invention,

FIG. 3 is a flow chart showing processes executed by the projector according to the embodiment of the invention,

FIG. 4 is a chart showing a state of an electric current of a USB terminal of the projector according to the embodiment of the invention, and

FIG. 5 is a chart showing output states of images from a PC, an external terminal and the projector according to the embodiment of the invention.

### DETAILED DESCRIPTION OF THE PREFERRED EMBODIMENTS

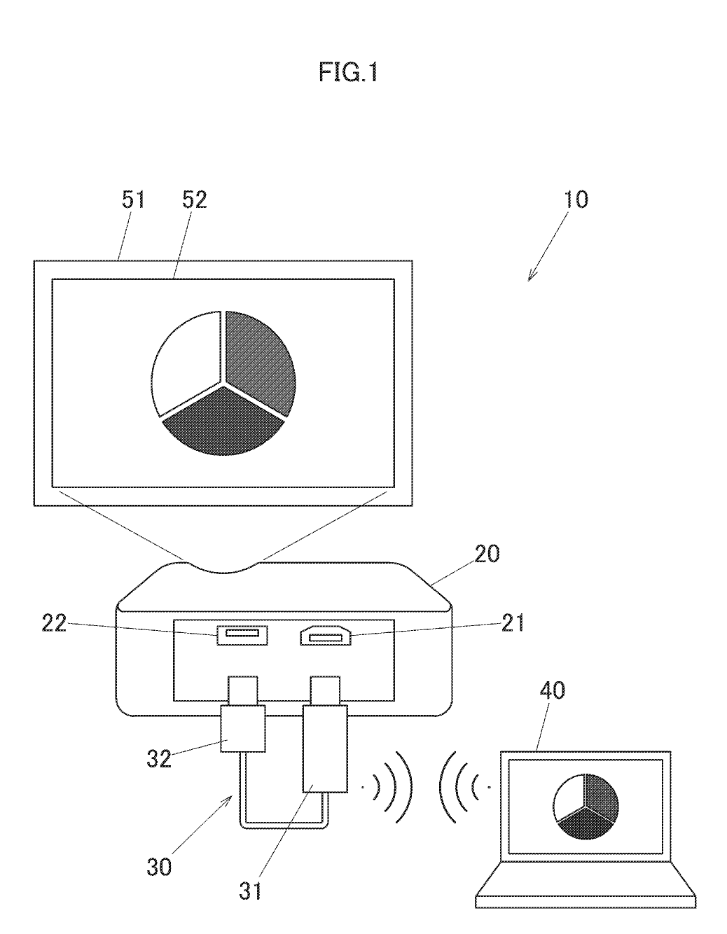

FIG. 1 is a drawing showing a projection system 10. The projection system (display system) 10 includes a projector 20, which is a display apparatus, an external terminal 30 that is connected to the projector 20, and a PC (Personal Computer) 40, which is an image data transmission terminal. The PC 40 and the external terminal 30 send and receive image data therebetween in a wireless fashion. The external terminal 30 outputs image data received from the PC 40 to the projector 20. The projector 20 projects the image data received from the external terminal 30 onto a screen 51 for display thereon.

The external terminal 30 has a main body portion 31 and a feeding plug 32. The main body portion 31 is connected with an HDMI (High-Definition Multimedia Interface) (an input terminal) 21 of the projector 20 to transmit image data to the projector 20. The feeding plug 32 is connected with a USB (Universal Serial Bus) terminal (a power supplying terminal) 22. The main body portion 31 is driven by being fed from the USB terminal 22.

The projector 20 projects image data inputted from the external terminal 30 thereinto by way of the HDMI terminal 21 onto a display unit such as the screen 51 for display an image 52 thereon. Thus, the projection system 10 can execute a mirroring in which an image displayed on the PC 40 is displayed on the screen 51.

Data that the PC 40 transmits to the external terminal 30 or the projector 20 is not limited to image data and can include other data such as audio or voice data, control data and the like. By doing so, the projector 20 can output voice or execute an operation instructed by the PC 40. In addition, the external terminal 30 may be configured to receive image data or voice data from a base station such as a wireless router that is a transmission terminal, not shown, in a wireless fashion to output the data to the projector 20.

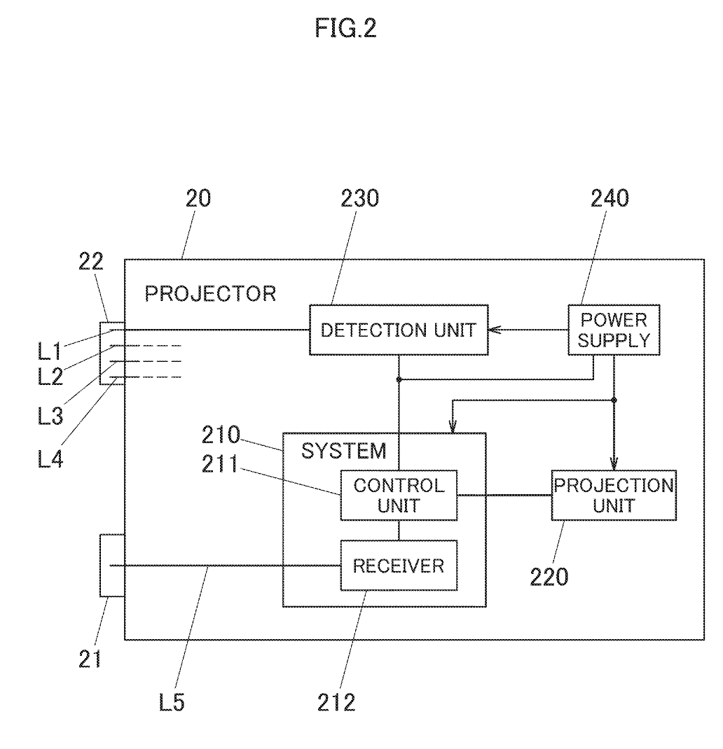

FIG. 2 is a block diagram showing functional blocks of the projector 20. The projector 20 includes a system 210, a projection unit (a display unit) 220, a detection unit 230 and a power supply 240. The system. 210 includes a control unit 211 configured to process image data and a receiver 212 configured to receive image data inputted from the HDMI terminal 21 thereinto byway of an input line L5. The system 210 can include other functional units such as a temperature sensor for monitoring a temperature inside the projector 20 and a fan for cooling an interior thereof.

The projection unit 220 projects an image based on the image data processed by the system 210 to an exterior portion. The projection unit 220 includes a light source for generating projection light, optical members such as mirrors and lenses for guiding light emitted from the light source and a display device such as a DMD (Digital Micromirror Device) for forming a projection image.

The projector 20 includes the HDMI terminal 21 and the USB terminal 22. The receiver 212 receives data such as image data, voice data, and control data which are inputted from the HDMI terminal 21 thereinto by way of the input line L5. The input line L5 represents a simplified data transmission line of the HDMI terminal 21, and the HDMI terminal 21 includes wirings such as a power supply line and a ground line.

The USB terminal 22 is used mainly to supply electric power to the external terminal 30 (refer to FIG. 1). The USB terminal 22 includes a feeding line L1, data lines L2, L3 and a ground line L4 as interior wirings. In these lines, the feeding line L1 constitutes a constant voltage source between the ground line L4 and itself and has a function to supply electric power to the external terminal 30 that is connected to the projector 20. Although an example of usage of the data lines L2, L3 is not shown in this embodiment, the data lines L2, L3 are used for data transmission between equipment connected with the projector 20 and itself.

The detection unit 230 detects an electric current that flows in the feeding line L1 of the USB terminal 22. In a case where no equipment is connected with the USB terminal 22, an output terminal of the feeding line L1 is opened, and therefore, an electric current value becomes substantially 0 [A]. Even though equipment is connected with the USB terminal 22, in a case where the equipment is not in operation, an electric current flowing in the feeding line L1 becomes substantially 0 [A] or takes a small value. On the other hand, in a case where equipment is connected with the USB terminal 22, since an electric current flows according to the magnitude of a load of the equipment (that is, the magnitude of consumed electric power), the value of the electric current flowing in the feeding line L1 is increased.

The power supply 240 supplies electric power to the system 210, the projection unit 220, and the detection unit 230. Additionally, the power supply 240 functions a voltage source or an electric current source that matches respective standards of the HDMI terminal 21 and the USB terminal 22 via a regulator unit, not shown. The control unit 211 can monitor or control the operation of the power supply 240.

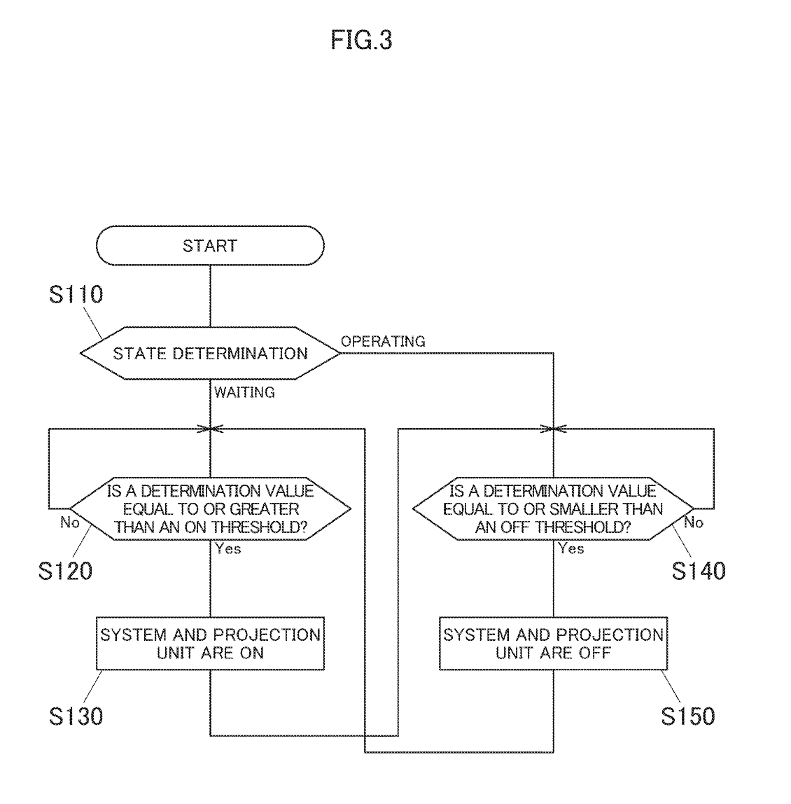

FIG. 3 is a flow chart showing processes executed by the detection unit 230 and the control unit 211 of the projector 20. The processes described in this flow chart are executed when a user turns on the power supply of the projector 20 or the user shifts the projector 20 into a mode where the projector 20 operates in association with the external terminal 30. Here, a case will be described in which the load of the external terminal 30 is small.

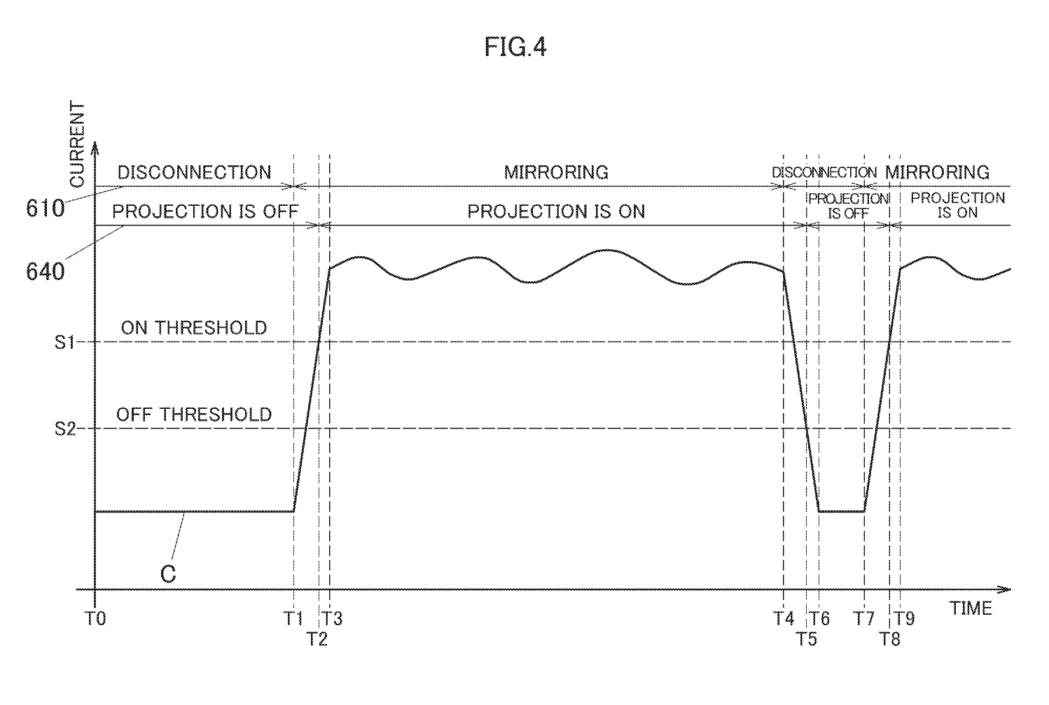

The detection unit 230 detects in step S110 a detection value that is associated with an input of a target image to be displayed from the external terminal. Then, the control unit 211 determines whether the projection unit 220 and the system 210 of the projector 20 are currently in a waiting state or an operating state. The state of the projector 20 can be determined by the detection unit 230 referring to a flag indicating an internal state stored in an appropriate storage unit. Alternatively, it may be determined by the control unit 211 that the projector 20 is in the waiting state in a case where an electric current value of the feeding line L1 is equal to or smaller than a predetermined threshold (for example, an OFF threshold (a second threshold) S2 in FIG. 4, which will be described later). If it is determined in step S110 that the projector 20 is in the waiting state, the detection unit 230 proceeds to a process in step S120. If it is determined in step S110 that the projector 20 is in the operating state, the control unit 211 proceeds to a process in step S140.

The detection unit 230 detects an electric current in the feeding line L1 in step S120. Then, the control unit 211 determines whether or not the electric current in the feeding line L1 is equal to or greater than a predetermined on threshold (a first threshold) that is greater than the OFF threshold (the second threshold) S2.

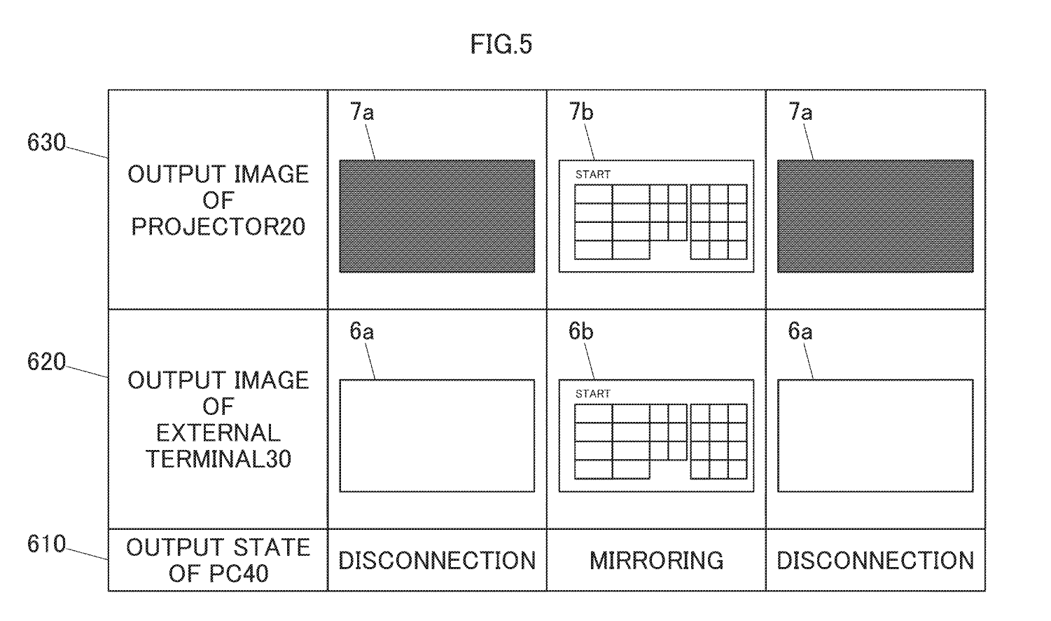

Here, referring to FIGS. 4 and 5, the determination of the electric current value in the feeding line L1 will be described. FIG. 4 is a chart showing a state of an electric current C in the feeding line L1 of the USB terminal 22. In addition, FIG. 5 is a chart showing output states of images from the PC 40, the external terminal 30 and the projector 20.

The external terminal 30 is put in a waiting state where no image is processed or reproduced (outputted) and an operating state where an image is processed or reproduced. Specifically speaking, in an initial state, as shown in FIG. 5, an output state 610 of the PC 40 is a disconnected state where no image data is transmitted to the external terminal 30. Because of this, the external terminal 30 is in the waiting state where no data is transmitted or received. As this occurs, as shown in FIG. 5, the external terminal 30 can output a standard image 6a indicating that the external terminal 30 is in the waiting state via the input line L5 as an output image 620 of the external terminal 30. The standard image 6a can be stored in advance in the external terminal 30.

In general, the consumed power of the external terminal 30 is increased in the operating state where the external terminal 30 communicates with the PC 40 and executes a graphic processing in an interior thereof, and the electric current C (refer to FIG. 4) that flows in the feeding line L1 provided as a positive pole of a constant voltage source is increased. Although the external terminal 30 of this embodiment outputs the standard image 6a to the projector 20 in the waiting state, since the standard image 6a does not require an image processing of a high load, the electric current C is small. Consequently, in a time period from a timing T0 to a timing T1 where the external terminal 30 is in the initial state, the electric current C that flows through the feeding line L1 to the external terminal 30 is smaller than the value of the ON threshold S1.

In this way, if it is not determined in step S120 in FIG. 3 that the value of electric current flowing through the feeding line L1 is equal to or greater than the ON threshold S1, the control unit 211 repeats the process in step S120.

Since it is determined that the external terminal 30 is in the waiting state, the system 210 and the projection unit 220 are in the waiting state (projection is off), an output image 630 (refer to FIG. 5) of the projector 20 becomes something like a projection image 7a. Namely, the projector 20 does not execute an operation to output the standard image 6a that is inputted from the external terminal 30.

On the other hand, if it is determined in step S120 in FIG. 3 that the value of electric current flowing through the feeding line L1 is equal to or greater than the ON threshold S1 (step S120: YES), the control unit 211 proceeds to a process in step S130.

Specifically, when the output state 610 of the PC 40 shifts to a state of mirroring at the timing T1 in FIG. 4, the PC 40 transmits image data displayed on a display unit of the PC 40 to the external terminal 30. Since the external terminal 30 is executing a process of communicating with the PC 40, the external terminal 30 shifts to a state where electric power is consumed much. The output image 620 of the external terminal 30 to the projector 20 becomes an image 6b to be displayed by the projector 20, and the external terminal 30 outputs the image 6b to the projector 20 by way of the input line L5 of the HDMI terminal 21. When the consumed electric power of the external terminal 30 is increased, the electric current C flowing through the feeding line L1 becomes equal to or greater than the ON threshold S1 at the timing T2 in FIG. 4.

In step S130, the control unit 211 transmits a command to drive the system 210 and the projection unit 220 to the power supply 230 to thereby shift the system 210 and the projection unit 220 into the operating state. Thus, the projection unit 220 projects the image 6b received from the external terminal 30 onto the screen 51, whereby the output image 630 of the projector 20 becomes an image 7b that is a target image to be displayed. In this way, the projector 20 can execute the mirroring process of displaying the image that is the target image displayed on the PC 40 onto the screen 51.

Thereafter, at the timing T3 in FIG. 4, the value of electric current flowing through the feeding line L1 shifts to a steady state corresponding to the load.

The detection unit 230 detects the electric current flowing through the feeding line L1 in step S140. Then, the control unit 211 determines whether or not the value of electric current flowing through the feeding line L1 is equal to or smaller than the OFF threshold (the second threshold) S2.

If it determines that the value of electric current flowing through the feeding line L1 is equal to or smaller than the OFF threshold S2 (step S140: YES), the control unit 211 proceeds to a process in step S150. Specifically, the output state 610 of the PC 40 shifts to a state of disconnection where the transmission of an image to the external terminal 30 is stopped at the timing T4 in FIG. 4. Then, the output image 620 of the external terminal 30 to the projector 20 shifts to the standard image 6a that indicates the state of waiting, whereby the external terminal 30 shifts to the state where it consumes less electric power. Thus, the electric current C flowing through the feeding line L1 shown in FIG. 4 becomes equal to or smaller than the OFF threshold S2 at the timing T5.

On the other hand, if it does not determine in step S140 that the value of electric current flowing through the feeding line L1 is equal to or smaller than the OFF threshold (step S140: NO), the control unit 211 repeats the process in step S140.

In step S150, the control unit 211 stops the operation of the system 210 and the projection unit 220 or stops part of the functions thereof. Consequently, the output image 630 of the projector 20 shifts to the projection image 7a that is produced by turning off the light source or reducing the amount of light emitted from the light source, whereby the state results where the amount of consumed electric power is reduced. In this way, the mirroring operation of the projector 20 is stopped. Thereafter, the value of electric current flowing through the feeding line L1 is reduced, resulting in a substantially steady state at a timing T6. The control unit 211 executes the process in step S120 after the step S150.

In the example shown in FIG. 4, after the timing T6, the value of electric current starts to increase to start mirroring again at a timing T7. Operations performed at timings T7, T8, T9 are similar to those performed at the timings T1, T2, T3. In this way, the projector 20 can turn off a projecting operation 640 at the timings T0 to T2 and the timings T5 to T8 and turn on the projecting operation 640 at the timings T2 to T5 and the timing T8 onward.

The process shown by the flow chart shown in FIG. 3 ends when the user stops using the projector 20 or shifts the projector 20 to the mode where the projector 20 does not operate in association with the external terminal 30.

Thus, in this embodiment, while the value of electric current flowing through the feeding line L1 is used as the detection values detected in steps S120 and S140, in place of electric current, the value of voltage in the feeding line L1, or the consumed electric power or the amount of consumed electric power of the external terminal 30 may be used.

In a case where the value of voltage is used as a detection value, the detection unit 230 can detect a line-to-line voltage between the feeding line L1 and the ground line L4. In addition, in a case where the value of consumed electric power is used as a detection value, the control unit 211 can obtain a value of electric power by the value of electric current flowing through the feeding line L1 and the line-to-line voltage between the feeding line L1 and the ground line L4. Further, in a case where the amount of consumed electric power is used as a detection value, the control unit 211 can obtain a value of electric power by the obtained electric power and an operating time of the external terminal 30 counted by an appropriate time counting unit inside the projector 20.

There may be a case where the feeding line L1, which is the output terminal of the direct-current constant voltage supply, includes an alternating-current component. Thus, the detection unit 230 can use the frequency of electric current or voltage as a detection value.

In a case where the value of voltage, electric power, amount of electric power, frequency of electric current or frequency of voltage is used as a detection value, as in the case of the electric current shown in FIG. 4, the control unit 211 can execute a process of proceeding to step S130 if the detection value becomes equal to or greater than the ON threshold S1 in step S120 and execute a process of proceeding to step S150 if the detection value becomes equal to or smaller than the OFF threshold S2 in step S140. Alternatively, with the ON threshold set at a value that is smaller than the OFF threshold value, the control unit 211 can execute a process of shifting the projector 20 into the operating state (projection is on) if the detection value becomes equal to or smaller than the ON threshold and execute a process of shifting the projector 20 into the waiting state (projection is off) if the detection value becomes equal to or greater than the OFF threshold.

While the two thresholds of the ON threshold S1 and the OFF threshold S2 are used as the thresholds, by determining a single determination threshold, whether the projector 20 is in the waiting state or the operating state may be determined based on the single determination threshold. As this occurs, the control unit 211 can execute a process of shifting the projector 20 into the operating state (projection is on) if the detection value is equal to or greater than the determination threshold and can execute a process of shifting the projector 20 into the waiting state (projection is off) if the detection value is smaller than the determination threshold.

Additionally, a plurality of elements in electric current, voltage, frequency of electric current or voltage, electric power and amount of electric power may be combined for use as a determination value. In a case where a plurality of types of determination values are used, the control unit 211 can shift the projector 20 from the waiting state to the operating state or from the operating state to the waiting state if either of the determination values meets its determination standard. Alternatively, the control unit 211 may use values resulting from adding weighted values to the detection values as determination values for steps S120 and S140.

In this way, the projector 20 can determine whether the external terminal 30 is in the waiting state or the operating state by monitoring the electric current or the like that is supplied from the USB terminal 22 to the external terminal 30. By doing so, in the waiting state, the control unit 211 shifts the projector 20 into a state where the projector 20 looks as it is in a standby state from the outside by operating the system 211 at a low level and turning off mainly the projection light. When the user resumes the mirroring process, the projector 20 can be activated for operation as required by turning on the operations of the system 210 and the projection unit 220 inside the projector 20.

### Second Embodiment

Next, a second embodiment of the invention will be described. Although the value of electric current or voltage in the feeding line L1 or the value of electric power based thereon is used as the detection value in the first embodiment, in the second embodiment, an image that is inputted from an external terminal 30 into a projector 20 as a detection value is analyzed by a receiver 212 to make an image determination to thereby make required determinations in steps S110, S120 and S140. Namely, the receiver 212 of this embodiment functions as a detection unit configured to determine on the state of the external terminal 30.

A determination method will be described in which a luminance distribution of an image is used as a detection value. In a case where the external terminal 30 does not receive image data from a PC 40, the external terminal 30 transmits the standard image 6a shown in FIG. 5 to the projector 20. In a case where the receiver 212 determines that the image inputted is the standard image 6a or that no image is inputted, the receiver 212 determines that the external terminal 30 is in a waiting state, whereas in a case where the receiver 212 does not determine that the image inputted is the standard image 6a, the receiver 212 determines that the external terminal 30 is in an operating state. The standard image 6a is stored in advance in the external terminal 30.

As to a method of determining whether or not the image inputted is the standard image 6a, the receiver 212 determines that the image inputted is the standard image 6a in a case where the luminance distribution of the standard image 6a varies less. Namely, in case an image whose luminance distribution varies less is used in the external terminal 30 as the standard image 6a, the determination method can be executed effectively using the luminance distribution.

As a luminance value of a certain pixel, values resulting from converting luminance values of RGB (red, green and blue) which make up the pixel into a gray scale using an arbitrary method such as an NTSC (National Television System Committee) weighted average method can be used. As a comparison unit in comparison of luminance, luminance may be compared pixel by pixel or average luminance values of divided portions resulting from dividing the whole of an image may be compared with one another. The number of divisions of the image can be eight, nine or sixteen.

The receiver 212 can detect a change with time in luminance of the image inputted from the external terminal 30 and determine that the image inputted is the standard image 6a in a case where the amount of change falls within a predetermined threshold.

Further, in the projector 20, the receiver 212 can store the standard image 6a of the external terminal 30 in an appropriate storage unit. Using an image inputted from the external terminal 30 as a detection value, the receiver 212 may determine whether or not the image inputted is the standard image 6a by comparing the image inputted with the image stored in the storage unit. In a case where no image is inputted from the external terminal 30 or the image inputted from the external terminal 30 is determined to be the standard image 6a, the receiver 212 determines that the external terminal 30 is in the waiting state. In a case where an image other than the standard image 6a is inputted from the external terminal 30, the receiver 212 can determine that the external terminal 30 is in the operating state.

The method of determining the state of the external terminal 30 used in the second embodiment may be combined together with the method of determining the state of the external terminal 30 using the feeding line L1 in the first embodiment for application.

Thus, in the embodiments of the invention described heretofore, although the projector 20 is described as being used as the display apparatus, a monitor may be used in which a display unit is integrated into a main body portion where a drawing process is carried out. The HDMI terminals 21 and the USB terminals 22 are provided on many display devices. Due to this, the projection method and the projection system of the embodiments of the invention can be applied not only to the projector 20 but also to other display methods and display systems easily and widely.

The external terminal 30 may be configured to be connected through wires by the USB terminal 22 including the feeding line L1 and the HDMI terminal 21 including the input line L5.

In the embodiments that have been described heretofore, although the HDMI terminal 21 is described as being used as the data transfer terminal, in a case where a standardized data transfer terminal that has difficulty in being used sufficiently as a feeding terminal is used as a data transfer terminal, the configurations of the embodiments can effectively be applied to the data transfer terminal.

The display method of the projector 20 described in each of the embodiments includes the first step of detecting the detection value that is associated with the image inputted from the external terminal 30 and the second step of controlling the operation of the display unit of the projector unit 220 based on the detected detection value (refer to FIG. 3).

Thus, as has been described heretofore, with the projector 20, the display system 10 and the display method according to the embodiments of the invention, it can advantageously be expected to reduce the long-term running costs by reducing the consumed electric power by turning on the light source of the projector 20 only when images are wanted to be displayed and turning off the system 210 and the projection unit 220 of the projector 20 when no image needs to be displayed. Additionally, since the projector 20 is operated at the low power level while it is in the waiting state, in a conference, a meeting or in a lesson, a risk can be reduced of people, students or pupils are interrupted from concentration to argument or learning by turning off the operation of the cooling fan and the projection by the projection unit 220 in the interior of the projector 20. In this way, the projector 20, the display method and the projection system 10 can execute the display operation smoothly in response to an output of an image from the external equipment.

With the projector 20 in which the detection unit 230 detects the value of electric current and/or voltage in the feeding line L1 as the detection value, the operating state of the external terminal 30 can be detected without transmission and reception of a special control signal between the projector 20 and the external terminal 30. Thus, the external terminal 30 does not have to include an exclusive program to deal with the projector 20, whereby the configurations of the embodiments can easily be applied thereto.

With the projector 20 in which the display unit is switched to the operating state in a case the detection value, which is electric current, voltage or amount of electric power, is equal to or greater than the predetermined first threshold and the display unit is switched to the waiting state in a case where the detection value is smaller than the second threshold that is smaller than the first threshold, even in a case where a change in voltage in the feeding line L1 is small due to the magnitude of the load, the operating state of the external terminal 30 can easily be detected by the projector 20.

With the projector 20 in which the display unit is switched to the waiting state in a case the detection value, which is voltage, frequency of electric power or frequency of voltage, is equal to or greater than the predetermined first threshold and the display unit is switched to the operating state in a case where the detection value is smaller than the second threshold that is smaller than the first threshold, even in a case where the voltage in the feeding line L1 changes or a change in voltage in the feeding line L1 is small due to the magnitude of the load, the operating state of the external terminal 30 can easily be detected by the projector 20.

With the projector 20 in which the input line L5 is formed on the data transfer terminal that is specified by the standard, data can be inputted into a terminal that includes no feeding line.

With the projector 20 in which the feeding line L1 is formed on the USB terminal 22, since USB terminals are generally provided on devices of various specifications, the configurations of the embodiments of the invention can easily be applied to various devices. Additionally, since the external terminal 30 requires no exclusive wiring for connection with other external equipment than the projector 20 for supply of electric power, the feeding wiring can be laid out within the limited space.

With the projector 20 in which the detection unit detects the luminance distribution of the image received from the input line L5 as the detection value to make a determination on the image, even though the external terminal 30 is configured to be supplied with no electric power from the projector 20, the operating state of the external terminal 30 can be detected without transmission and reception of exclusive control signals therebetween.

With the projector 20 in which the detection unit makes a determination on the image by determining whether or not the luminance distribution or the change with time of the luminance distribution differs by the amount corresponding to or greater than the predetermined threshold, the input of the target display image can easily be detected.

With the projector 20 in which the image that the external terminal 30 receives from the transmission terminal (the PC 40) in a wireless fashion is inputted thereinto, the image of the transmission terminal disposed far away therefrom can easily be displayed.

With the projector 20 in which the image is displayed by being projected to the exterior portion by the display unit (the projection unit 220, the screen 51), even though the image display plane is disposed in the position situated far away from the display apparatus, the image of the external terminal 30 can easily be displayed.

These embodiments are presented as the examples and are not intended at all to limit the scope of the invention. The novel embodiments can be carried out in other various forms, and hence, various omissions, replacements and modifications can be made thereto without departing from the spirit and scope of the invention. The resulting embodiments and their modifications are included in the spirit and scope of the invention and are also included in the scope of inventions claimed for patent in claims and their equivalents.

What is claimed is:

1. A display apparatus comprising:
a display unit configured to display an image;
a detection unit configured to detect a detection value associated with an input of the image that is outputted from an external terminal; and
a control unit configured to control an operation of the display unit based on the detection value detected by the detection unit.

2. The display apparatus according to claim 1, comprising:
an electric power supplying terminal fur use in supplying electric power to the external terminal; and
an input terminal into which the image outputted from the external terminal is inputted, wherein
the detection unit detects an electric current and/or voltage of the electric power supplying terminal as the detection value.

3. The display apparatus according to claim 2, wherein
the control unit shifts the display unit into an operating state or a waiting state where a light source is turned off or an amount of light emitted from the light source is reduced.

4. The display apparatus according to claim 2, wherein
the control unit switches the display unit into an operating state in a case where the detection value, which is electric current, voltage or amount of electric power, is equal to or greater than a predetermined first threshold and switches the display unit into a waiting state in a case where the detection value is equal to or smaller than a second threshold that is smaller than the first threshold.

5. The display apparatus according to claim 3, wherein
the control unit switches the display unit into an operating state in a case where the detection value, which is electric current, voltage or amount of electric power, is equal to or greater than a predetermined first threshold and switches the display unit into a waiting state in a case where the detection value is equal to or smaller than a second threshold that is smaller than the first threshold.

6. The display apparatus according to claim 2, wherein
the control unit switches the display unit into a waiting state in a case where the detection value, which is voltage, frequency of electric current or frequency of voltage, is equal to or greater than a predetermined first threshold and switches the display unit into an operating state in a case where the detection value is equal to or smaller than a second threshold that is smaller than the first threshold.

7. The display apparatus according to claim 3, wherein
the control unit switches the display unit into a waiting state in a case where the detection value, which is voltage, frequency of electric current or frequency of voltage, is equal to or greater than a predetermined first threshold and switches the display unit into an operating state in a case where the detection value is equal to or smaller than a second threshold that is smaller than the first threshold.

8. The display apparatus according to claim 2, wherein
the input terminal is a data transfer terminal specified under a standard.

9. The display apparatus according to claim 3, wherein
the input terminal is a data transfer terminal specified under a standard.

10. The display apparatus according to claim 4, wherein
the input terminal is a data transfer terminal specified under a standard.

11. The display apparatus according to claim 5, wherein
the input terminal is a data transfer terminal specified under a standard.

12. The display apparatus according to claim 6, wherein
the input terminal is a data transfer terminal specified under a standard.

13. The display apparatus according to claim 7, wherein
the input terminal is a data transfer terminal specified under a standard.

14. The display apparatus according to claim 2, wherein
the electric power supplying terminal is made up of a USB terminal.

15. The display apparatus according to claim 2, wherein
the control unit detects a luminance distribution of the image received from the input terminal as the detection value to make a determination on the image.

16. The display apparatus according to claim 8, wherein
the control makes a determination on the image by determining whether or not the luminance distribution or a change with time of the luminance distribution differs by an amount corresponding to or greater than a predetermined threshold.

17. The display apparatus according to claim 1, wherein
the external terminal inputs the image received from a transmission terminal in a wireless fashion.

18. The display apparatus according to claim 1, wherein
the display unit display the image by projecting the image to an exterior portion.

19. A display method for a display apparatus that includes a display unit configured to display an image, comprising:
a first step of detecting a detection value that is associated with an input of the image that is outputted from an external terminal; and
a second step of controlling an operation of the display unit based on the detected detection value.

20. A display system comprising:
an external terminal configured to output an image; and
a display apparatus comprising a display unit, a power supplying terminal that is used to supply electric power to the external terminal, an input terminal into which the image outputted from the external terminal is inputted and a control unit configured to control an operation of the display unit based on a detection value that is associated with an input of the image that is inputted by way of the input terminal.
